(19) United States
(12) Patent Application Publication
(10) Pub. No.: US 2012/0211152 A1
(43) Pub. Date: Aug. 23, 2012

(54) DISC LABEL APPLICATOR SYSTEM AND METHOD

(76) Inventor: Etienne Bouthiette, Ste-Brigitte-de-Laval (CA)

(21) Appl. No.: 13/322,837

(22) PCT Filed: Jan. 5, 2010
(86) PCT No.: PCT/CA2010/000004

§ 371 Date: May 11, 2012

(30) Foreign Application Priority Data
May 27, 2009 (CA) 2,666,901

(51) Int. Cl. B65C 1/02; B32B 33/00; B65C 9/26

(52) U.S. Cl. 156/249; 156/538; 428/40.1

(57) ABSTRACT

A label applicator system for applying a disc-shaped label on a top surface of a disc. The system comprises an applicator base structure with a disc support structure and a handling tab support surface. The label is produced from a label sheet. The label sheet has tearing lines and cuts therein made in such a manner and position as to leave a part of a bottom layer of the sheet glued onto the bottom surface of a top layer in the form of a handling tab when the label is peeled off from the label sheet. At least one perforation is formed within the handling tab to extend over a corresponding at least one alignment post on the applicator base structure for installation and alignment of the label on the disc. A method of applying such a label on a disc is also disclosed.

### FIELD OF THE INVENTION

The present invention generally relates to systems for applying labels to products. More particularly, it relates to an applicator system for applying a label on optical discs. It also relates to a method for applying a label on optical discs using such an applicator system. It also relates to the sheets from which the labels may be extracted.

### BACKGROUND OF THE INVENTION

Several different systems have been developed to allow users of recordable optical discs to customize their discs through application of a label thereon.

U.S. Pat. No. 7,302,982 discloses a label applicator including a support surface having a central area and curving downwardly from the central area. The curved surface flattens out as the article is pressed down, allowing the label to be smoothly applied to the article.

U.S. Pat. No. 6,585,021 teaches a CD label applicator kit including a case, a support device and an applicator tool. The support device has an alignment post, a hub and a spring. The alignment post is fixed to an outer wall of the cover and extends outwardly through the opening. The spring biases the hub to a raised position in which the disk-receiving surface is above the label plate.

U.S. Pat. No. 6,405,777 discloses a compact cylindrical cap labelling device for applying self adhesive labels onto optical discs. The structure of the device results in a concentrically fixed and stationary position of a compact cylindrical cap labelling device over the optical disc surface and therefore provides a method for affixing self adhesive labels onto optical discs with claimed superior results.

U.S. Pat. No. 5,951,819 describes an apparatus for applying labels on optical discs having a base capable of supporting a label, as well as a plunger element capable of supporting and positioning the optical disc with respect to the label. A means to equalize pressure is provided on the plunger element or the base to prevent pressure differentials.

However, there is still presently a need for a label applicator system and associated method that helps facilitate alignment of the label while improving application of pressure when applying the label on the disc.

### SUMMARY OF THE INVENTION

An object of the present invention is to propose a label applicator system and method that satisfies at least one of the above-mentioned needs.

According to the present invention, that object is accomplished with a label applicator system for applying a disc-shaped label on a top surface of a disc, the label applicator system comprising:
an applicator base structure comprising:
   a disc support structure; and
   a handling tab support surface attached to the disc support structure and comprising at least one alignment post extending vertically away from the handling tab support surface, the handling tab support surface being generally in alignment with the top surface of the disc when the disc is inserted in the disc support structure;
      wherein the label is produced from a label sheet comprising:
a top layer having an upper surface and a lower surface, the lower surface being covered with a pressure sensitive adhesive glue; and
a bottom layer having an upper surface detachably fixed to the lower surface of the top layer by means of the adhesive glue, the bottom layer being peelable from the lower surface of the top layer to allow fixation of the disc-shaped label from the label sheet onto the top surface of the disc, the top and bottom layers having tearing lines punched therein, the bottom layer having a first cut, the top layer having a second cut that is disc-shaped, all the tearing lines and cuts made in such a manner and position as to leave a part of the bottom layer glued onto the bottom surface of the top layer in the form of a handling tab when the disc-shaped label is peeled off from the label sheet, the top and bottom layers further having at least one perforation formed within the handling tab, the at least one perforation being sized and positioned so as to extend over the corresponding at least one alignment post of the handling tab support surface when the label is inserted on the applicator base structure for installation of the label on the disc, thus allowing an edge of the label opposite the handling tab to be applied to the disc and then allowing a gradual application of a pressure to a remainder of the label through a movement extending from the edge towards the handling tab which is peelable away from the label.

According to the present invention, there is also provided a label sheet for use with a label applicator system for applying a disc-shaped label on a top surface of a disc, the label applicator system comprising an applicator base structure, the base structure comprising a disc support structure and a handling tab support surface, the support surface attached to the disc support structure and comprising at least one alignment post extending vertically away from the handling tab support surface, the handling tab support surface being generally in alignment with the top surface of the disc when the disc is inserted in the disc support structure, the label sheet comprising:
a top layer having an upper surface and a lower surface, the lower surface being covered with a pressure sensitive adhesive glue; and
a bottom layer having an upper surface detachably fixed to the lower surface of the top layer by means of the adhesive glue, the bottom layer being peelable from the lower surface of the top layer to allow fixation of the disc-shaped label from the label sheet onto the top surface of the disc, the top and bottom layers having tearing lines punched therein, the bottom layer having a first cut, the top layer having a second cut that is disc-shaped, all the tearing lines and cuts made in such a manner and position as to leave a part of the bottom layer glued onto the bottom surface of the top layer in the form of a handling tab when the disc-shaped label is peeled off from the label sheet, the top and bottom layers further having at least one perforation formed within the handling tab, the at least one perforation being sized and positioned so as to extend over the corresponding at least one alignment post of the handling tab support surface when the label is inserted on the applicator base structure for installation of the label on the disc, thus allowing an edge of the label opposite the handling tab to be applied to the disc and then allowing a gradual application of a pressure to a remainder of the label through a movement extending from the edge towards the handling tab which is peelable away from the label.

According to the present invention, there is also provided a method of applying a disc-shaped label to a top surface of a disc, the method comprising the steps of:
a) providing an applicator base structure comprising:
   a disc support structure; and
   a handling tab support surface attached to the disc support structure and comprising at least one alignment post extending vertically away from the handling tab support surface, the handling tab support surface being generally in alignment with the top surface of the disc when the disc is inserted in the disc support structure;
b) providing a label produced from a label sheet, the label sheet comprising:
   a top layer having an upper surface and a lower surface, the lower surface being covered with a pressure sensitive adhesive glue; and
   a bottom layer having an upper surface detachably fixed to the lower surface of the top layer by means of the adhesive glue, the bottom layer being peelable from the lower surface of the top layer to allow fixation of the disc-shaped label from the label sheet onto the top surface of the disc, the top and bottom layers having tearing lines punched therein, the bottom layer having a first cut, the top layer having a second cut that is disc-shaped, all the tearing lines and cuts made in such a manner and position as to leave a part of the bottom layer glued onto the bottom surface of the top layer in the form of a handling tab when the disc-shaped label is peeled off from the label sheet, the top and bottom layers further having at least one perforation formed within the handling tab, the at least one perforation being sized and positioned so as to extend over the corresponding at least one alignment post of the handling tab support surface when the label is inserted on the applicator base structure for installation of the label on the disc;
c) tearing the handling tab away from the label sheet along the tearing lines;
d) peeling the label away from the label sheet using the handling tab;
e) inserting the handling tab on the handling tab support surface
f) applying pressure on an edge of the label opposite the handling tab to the disc;
g) peeling away the handling tab from the label; and
h) gradually applying pressure to a remainder of the label through a movement extending from the edge towards the opposite edge of the label.

The label applicator system and method according to the present invention help minimize the formation of air bubbles when applying a self-adhesive label on a disc while improving alignment of the label with respect to the disc. The system and method also help avoid any creases while providing greater stability in the application of the label on the disc.

A non-restrictive description of a preferred embodiment of the invention will now be given with reference to the appended drawings.

### BRIEF DESCRIPTION OF THE DRAWINGS

FIG. 1 is a top view of a label sheet to be used in conjunction with the label applicator system in accordance with a preferred embodiment of the present invention;

FIG. 2 is a perspective view of the label applicator system in accordance with a preferred embodiment of the present invention;

FIG. 3 is a side view of the label applicator system shown in FIG. 2;

FIG. 4 is a top view of the label applicator system shown in FIG. 2;

FIG. 5 is a front view of the label applicator system shown in FIG. 2;

FIGS. 6A to 6J are perspective views showing the label preparation and installation steps using a label applicator system in accordance with a preferred embodiment of the present invention;

FIG. 7 is a top view of another label sheet to be used in conjunction with a label applicator system in accordance with another preferred embodiment of the present invention;

FIG. 8 is a perspective view of another label applicator system in accordance with another preferred embodiment of the present invention;

FIG. 9 is a side view of the label applicator system shown in FIG. 8;

FIG. 10 is a top view of the label applicator system shown in FIG. 8;

FIG. 11 is a front view of the label applicator system shown in FIG. 8;

FIG. 12 is a top view of another label sheet to be using in conjunction with a label applicator system in accordance with another preferred embodiment of the present invention;

FIG. 13 is a perspective view of another label applicator system in accordance with another preferred embodiment of the present invention;

FIG. 14 is a side view of the label applicator system shown in FIG. 13;

FIG. 15 is a top view of the label applicator system shown in FIG. 13;

FIG. 16 is a front view of the label applicator system shown in FIG. 13.

### DESCRIPTION OF PREFERRED EMBODIMENTS

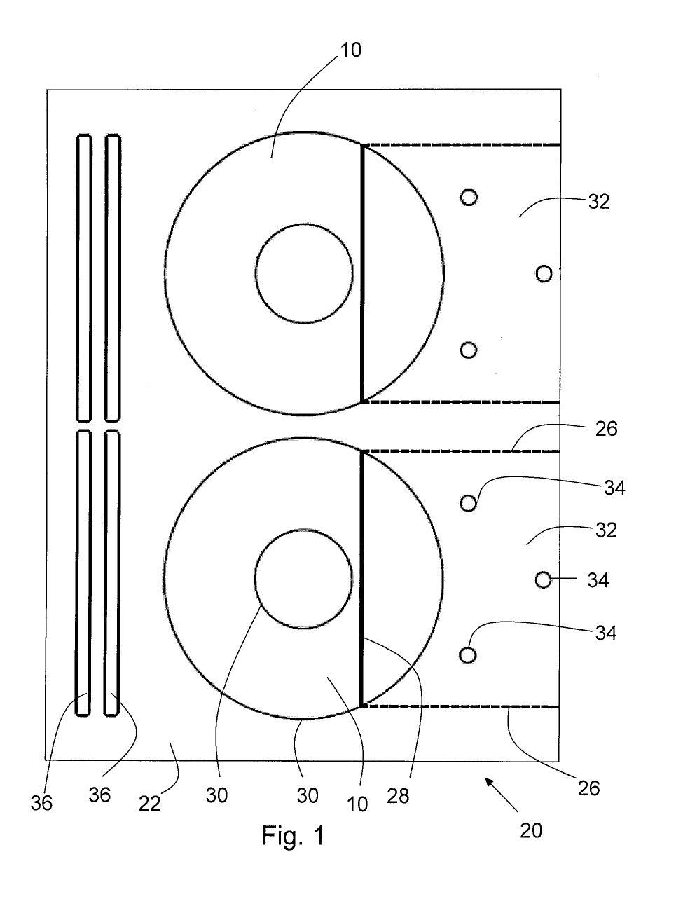

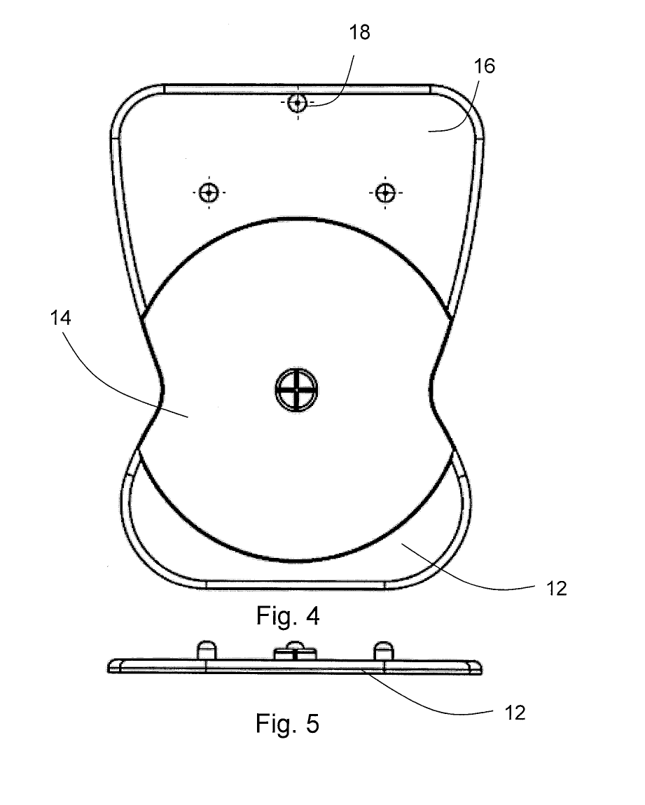

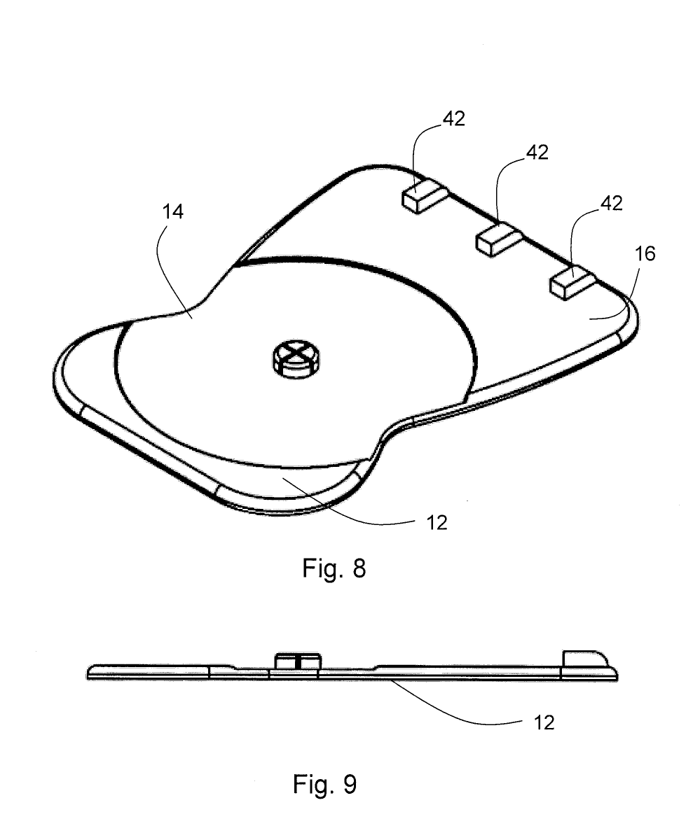

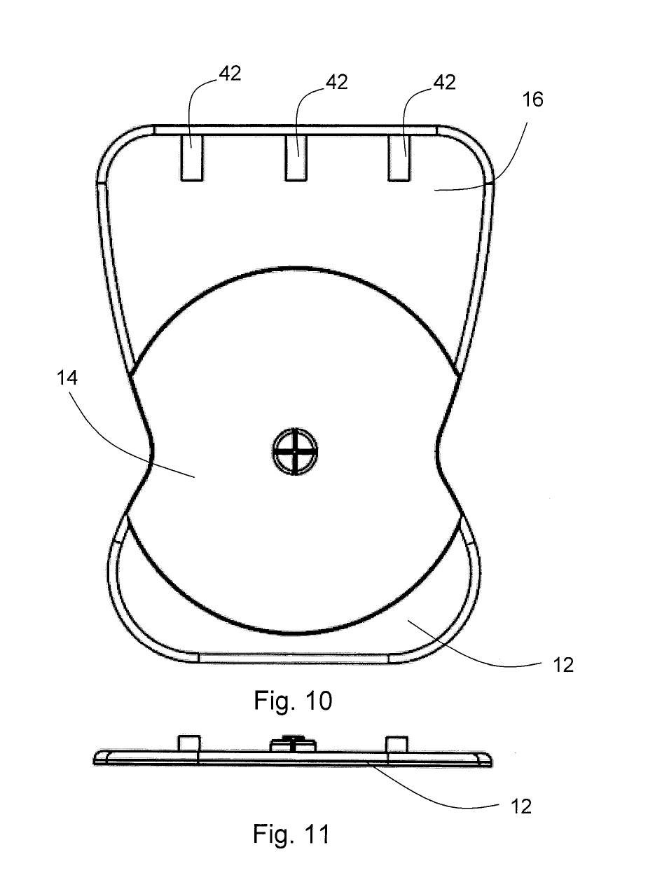

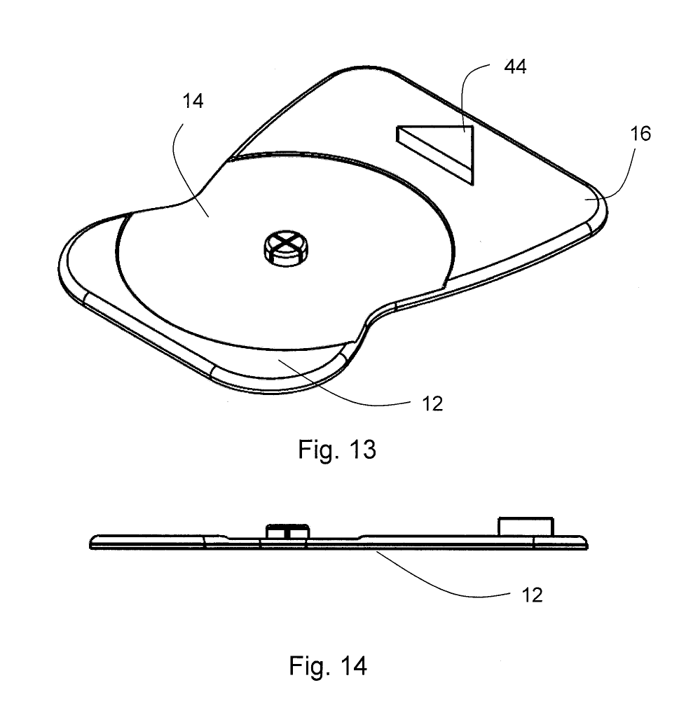

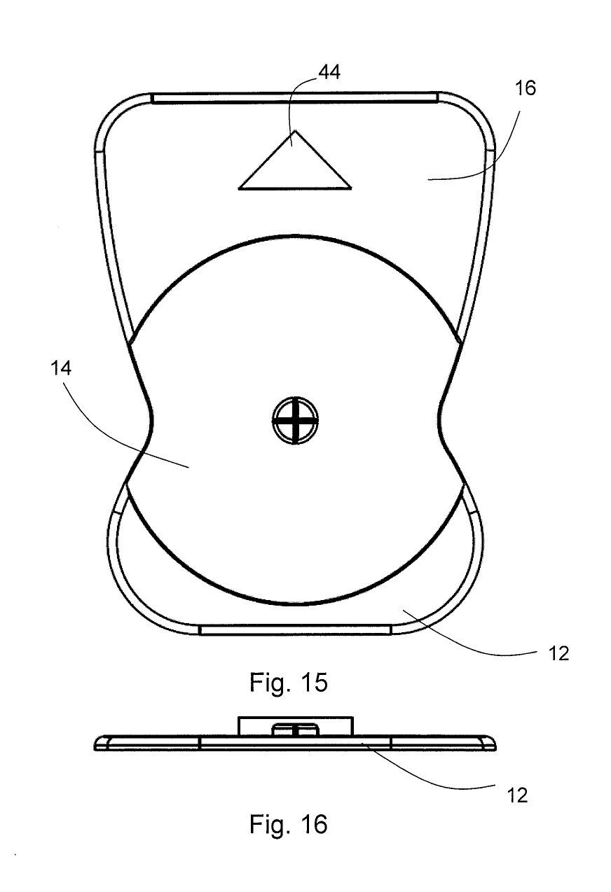

Referring to any one of FIGS. 1 to 16, a label applicator system is disclosed.

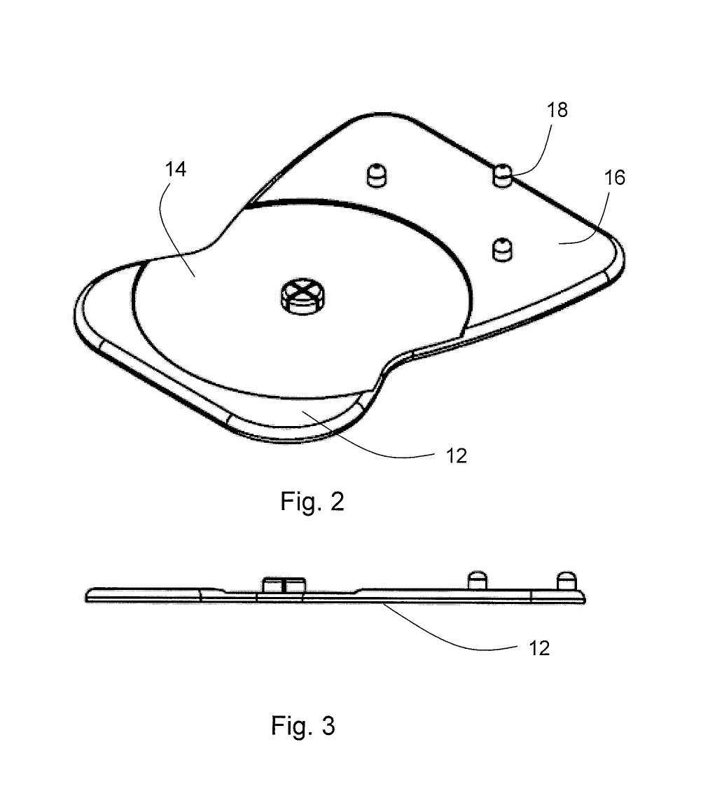

The system is used for applying a disc-shaped label 10 as shown in FIG. 1, on a top surface of a disc. The system comprises an applicator base structure 12, shown in FIGS. 2 to 5. The base structure 12 comprises a disc support structure 14 and a handling tab support surface 16 attached to the disc support structure 14. The handling tab support surface 16 comprises at least one alignment post 18 extending vertically away from the handling tab support surface 16. The handling tab support surface 16 is generally in alignment with the top surface of the disc when the disc is inserted in the disc support structure 14.

As better shown in FIG. 1, the label 10 is produced from a label sheet 20. The label sheet 20 includes a top layer 22 having an upper surface and a lower surface. The lower surface is covered with a pressure sensitive adhesive glue. The label sheet 20 also includes a bottom layer having an upper surface detachably fixed to the lower surface of the top layer by means of the adhesive glue. The bottom layer is peelable from the lower surface of the top layer to allow fixation of the disc-shaped label 10 from the label sheet 20 onto the top surface of the disc. The top and bottom layers have tearing lines 26 punched therein. The bottom layer has a first cut 28. The top layer has a second cut 30 that is disc-shaped. All the tearing lines 26 and cuts 28,30 are made in such a manner and position as to leave a part of the bottom layer glued onto the bottom surface of the top layer in the form of a handling tab 32 when the disc-shaped label is peeled off from the label sheet. The top and bottom layers further have at least one perforation 34 formed within the handling tab 32. The at least one perforation 34 is sized and positioned so as to extend over the corresponding at least one alignment post 18 of the handling tab support surface 16 when the label is inserted on the applicator base structure for installation of the label on the disc. This allows an edge of the label opposite the handling tab to be applied to the disc and then allows a gradual application of a pressure to a remainder of the label through a movement extending from the edge towards the handling tab 32 which is peelable away from the label 10.

Preferably, the label sheet is made of paper. The label itself may be made of plastic or any other material known in the art.

Preferably, the upper surface of the bottom layer of the label sheet is covered with silicone.

Preferably, the label sheet also comprises a pair of case spine labels 36 made with a cut through a top layer of the label sheet.

Preferably, a single label sheet includes a pair of disc-shaped labels for installation on discs.

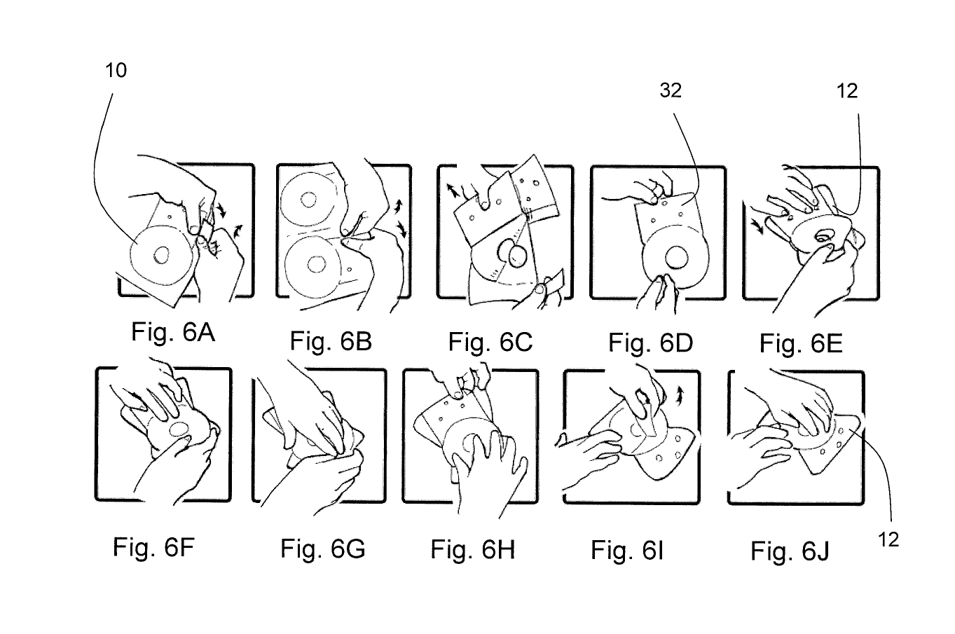

According to the present invention, as better shown in FIGS. 6A to 6J, there is also provided a method of applying a disc-shaped label to a top surface of a disc, the method comprising the steps of:
a) providing an applicator base structure comprising:
   a disc support structure; and
   a handling tab support surface attached to the disc support structure and comprising at least one alignment post extending vertically away from the handling tab support surface, the handling tab support surface being generally in alignment with the top surface of the disc when the disc is inserted in the disc support structure;
b) providing a label produced from a label sheet, the label sheet comprising:
   a top layer having an upper surface and a lower surface, the lower surface being covered with a pressure sensitive adhesive glue; and
   a bottom layer having an upper surface detachably fixed to the lower surface of the top layer by means of the adhesive glue, the bottom layer being peelable from the lower surface of the top layer to allow fixation of the disc-shaped label from the label sheet onto the top surface of the disc, the top and bottom layers having tearing lines punched therein, the bottom layer having a first cut, the top layer having a second cut that is disc-shaped, all the tearing lines and cuts made in such a manner and position as to leave a part of the bottom layer glued onto the bottom surface of the top layer in the form of a handling tab when the disc-shaped label is peeled off from the label sheet, the top and bottom layers further having at least one perforation formed within the handling tab, the at least one perforation being sized and positioned so as to extend over the corresponding at least one alignment post of the handling tab support surface when the label is inserted on the applicator base structure for installation of the label on the disc;
c) tearing the handling tab away from the label sheet along the tearing lines, as shown in FIGS. 6A and 6B;
d) peeling the label away from the label sheet using the handling tab, as shown in FIGS. 6C and 6D;
e) inserting the handling tab on the handling tab support surface as shown in FIG. 6E;
f) applying pressure on an edge of the label opposite the handling tab to the disc, as shown in FIGS. 6F to 6H;
g) peeling away the handling tab from the label, as shown in FIG. 6I; and
h) gradually applying pressure to a remainder of the label through a movement extending from the edge towards the opposite edge of the label, as shown in FIG. 6J.

This method and system of applying a label on a disc helps improve alignment of the label on the disc, while minimizing the formation of bubbles between the label and the disc when applying the label on the disc. The system and method also help avoid any creases while providing greater stability in the application of the label on the disc.

Preferably, in the embodiment of the invention shown in FIGS. 1 to 6J, the system comprises a plurality of alignment posts that are substantially cylindrical in shape and the perforations are substantially circular. However, several different shapes of posts or perforations can be used.

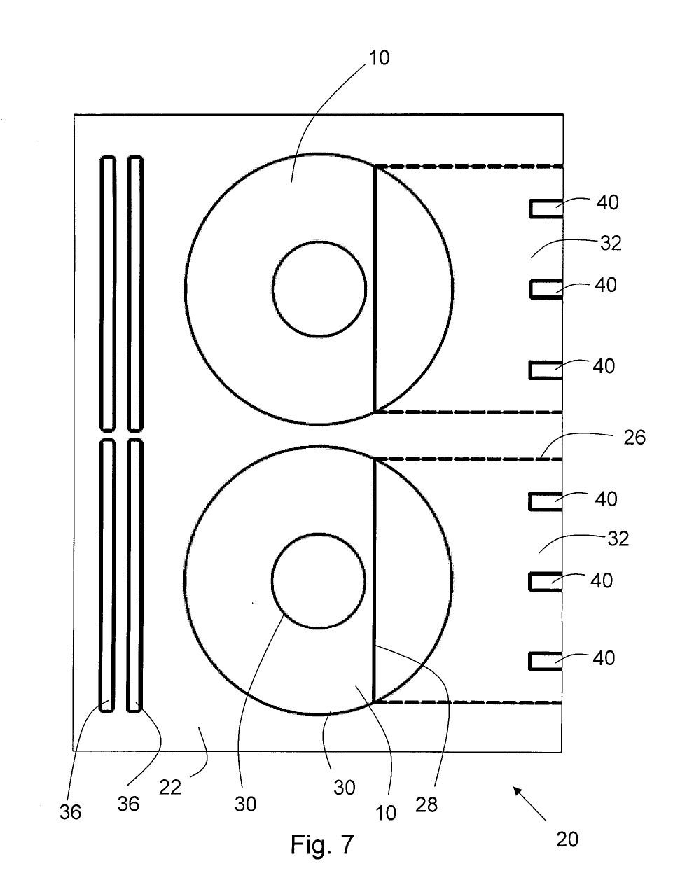

FIGS. 7 to 11 show another embodiment of the invention, wherein the perforations 40 are slot-shaped and the alignment posts 42 are shaped to correspond to the slot-shaped perforations.

The perforations and the corresponding alignment posts can be in any shape and configuration that allow proper alignment of the label sheet on the applicator base structure.

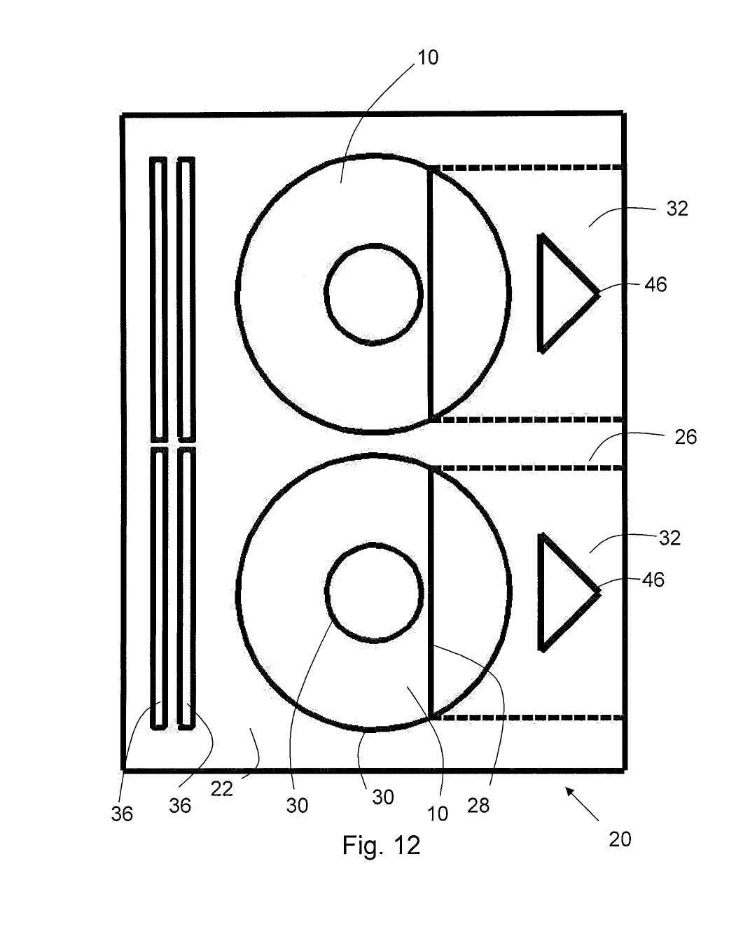

FIGS. 12 to 16 show yet another embodiment of the invention, wherein a single alignment post 44 of the label applicator system is shaped to prevent rotation of the label (through the corresponding perforation 46) about the alignment post upon installation thereon. In the illustrated embodiment, the chosen shape is triangular, but any other appropriate shape performing the same function may be used.

Although the present invention has been explained hereinabove by way of preferred embodiments thereof, it should be pointed out that any modifications to these preferred embodiments within the scope of the appended claims is not deemed to alter or change the nature and scope of the present invention.

1.-24. (canceled)

25. A label applicator system for applying a disc-shaped label on a top surface of a disc, said label applicator system comprising:
an applicator base structure comprising:
a disc support structure; and
a handling tab support surface attached to the disc support structure and comprising at least one alignment post extending vertically away from the handling tab support surface, said handling tab support surface being generally in alignment with the top surface of the disc when the disc is inserted in the disc support structure;
wherein the label is produced from a label sheet comprising:
a top layer having an upper surface and a lower surface, said lower surface being covered with a pressure sensitive adhesive glue; and
a bottom layer having an upper surface detachably fixed to the lower surface of the top layer by means of said adhesive glue, said bottom layer being peelable from the lower surface of the top layer, said top and bottom layers having tearing lines punched therein, the bottom layer having a first cut, the top layer having a second cut that is disc-shaped and defines the disc-shaped label, all said tearing lines and cuts made in such a manner and position as to leave a part of said bottom layer glued onto the bottom surface of the top layer in the form of a handling tab when said disc-shaped label is peeled off from the label sheet, said top and bottom layers further having at least one perforation formed within said handling tab, said at least one perforation being sized and positioned so as to extend over the corresponding at least one alignment post of the handling tab support surface when the label is inserted on the applicator base structure for installation of the label on the disc, thus allowing an edge of the label opposite the handling tab to be applied to the disc and then allowing a gradual application of a pressure to a remainder of the label through a movement extending from said edge towards the handling tab which is peelable away from the label.

26. The label applicator system according to claim 25, wherein said label sheet is made of paper.

27. The label applicator system according to claim 25, wherein the upper surface of the bottom layer of the label sheet is covered with silicone.

28. The label applicator system according to claim 25, the system comprising a plurality of alignment posts and a corresponding plurality of perforations and wherein the plurality of alignment posts are substantially cylindrical in shape and the plurality of perforations are substantially circular.

29. The label applicator system according to claim 25, the system comprising a plurality of alignment posts and a corresponding plurality of perforations, and wherein the perforations are slot-shaped and the alignment posts are shaped to correspond to said slot-shaped perforations.

30. The label applicator system according to claim 25, wherein the at least one alignment post is shaped to prevent rotation of the label about the at least one alignment post upon installation thereon.

31. The label applicator system according to claim 25, wherein the label sheet further comprises a pair of case spine labels made with a cut through the top layer of the label sheet.

32. The label applicator system according to claim 25, wherein the label sheet comprises a pair of disc-shaped labels for installation on discs.

33. A label sheet for use with a label applicator system for applying a disc-shaped label on a top surface of a disc, said label applicator system comprising an applicator base structure, said base structure comprising a disc support structure and a handling tab support surface, said support surface attached to the disc support structure and comprising at least one alignment post extending vertically away from the handling tab support surface, said handling tab support surface being generally in alignment with the top surface of the disc when the disc is inserted in the disc support structure, said label sheet comprising:
a top layer having an upper surface and a lower surface, said lower surface being covered with a pressure sensitive adhesive glue; and
a bottom layer having an upper surface detachably fixed to the lower surface of the top layer by means of said adhesive glue, said bottom layer being peelable from the lower surface of the top layer, said top and bottom layers having tearing lines punched therein, the bottom layer having a first cut, the top layer having a second cut that is disc-shaped and defines the disc-shaped label, all said tearing lines and cuts made in such a manner and position as to leave a part of said bottom layer glued onto the bottom surface of the top layer in the form of a handling tab when said disc-shaped label is peeled off from the label sheet, said top and bottom layers further having at least one perforation formed within said handling tab, said at least one perforation being sized and positioned so as to extend over the corresponding at least one alignment post of the handling tab support surface when the label is inserted on the applicator base structure for installation of the label on the disc, thus allowing an edge of the label opposite the handling tab to be applied to the disc and then allowing a gradual application of a pressure to a remainder of the label through a movement extending from said edge towards the handling tab which is peelable away from the label.

34. The label sheet according to claim 33, wherein said label sheet is made of paper.

35. The label sheet according to claim 33, wherein the upper surface of the bottom layer of the label sheet is covered with silicone.

36. The label sheet according to claim 33, wherein the label applicator system comprises a plurality of alignment posts and a corresponding plurality of perforations, and the plurality of alignment posts are substantially cylindrical in shape and the plurality of perforations are substantially circular.

37. The label sheet according to claim 33, wherein the label applicator system comprises a plurality of alignment posts and a corresponding plurality of perforations, the perforations are slot-shaped and the alignment posts are shaped to correspond to said slot-shaped perforations.

38. The label sheet according to claim 33, wherein the at least one alignment post of the label applicator system is shaped to prevent rotation of the label about the at least one alignment post upon installation thereon.

39. The label sheet according to claim 33, wherein the label sheet further comprises a pair of case spine labels made with a cut through the top layer of the label sheet.

40. The label sheet according to claim 33, wherein the label sheet comprises a pair of disc-shaped labels for installation on discs.

41. A method of applying a disc-shaped label to a top surface of a disc, said method comprising the steps of:
a) providing an applicator base structure comprising:
a disc support structure; and
a handling tab support surface attached to the disc support structure and comprising at least one alignment post extending vertically away from the handling tab support surface, said handling tab support surface being generally in alignment with the top surface of the disc when the disc is inserted in the disc support structure;
b) providing a label produced from a label sheet, said label sheet comprising:
a top layer having an upper surface and a lower surface, said lower surface being covered with a pressure sensitive adhesive glue; and
a bottom layer having an upper surface detachably fixed to the lower surface of the top layer by means of said adhesive glue, said bottom layer being peelable from the lower surface of the top layer, said top and bottom layers having tearing lines punched therein, the bottom layer having a first cut, the top layer having a second cut that is disc-shaped and defines the disc-shaped label, all said tearing lines and cuts made in such a manner and position as to leave a part of said bottom layer glued onto the bottom surface of the top layer in the form of a handling tab when said disc-shaped label is peeled off from the label sheet, said top and bottom layers further having at least one perforation formed within said handling tab, said at least one perforation being sized and positioned so as to extend over the corresponding at least one alignment post of the handling tab support surface when the label is inserted on the applicator base structure for installation of the label on the disc;
c) tearing the handling tab away from the label sheet along the tearing lines;
d) peeling the label away from the label sheet using the handling tab;
e) inserting the handling tab on the handling tab support surface;
f) applying pressure on an edge of the label opposite the handling tab to contact the label to the disc;
g) peeling the handling tab away from the label; and
h) applying pressure to a remainder of the label through a movement extending from said edge towards the opposite edge of the label.

42. The method according to claim 41, wherein said label sheet is made of paper.

43. The method according to claim 41, wherein the upper surface of the bottom layer of the label sheet is covered with silicone.

44. The method according to claim 41, wherein the label applicator system comprises a plurality of alignment posts and a corresponding plurality of perforations, the plurality of alignment posts are substantially cylindrical in shape and the plurality of perforations are substantially circular.

45. The method according to claim 41, wherein the label applicator system comprises a plurality of alignment posts and a corresponding plurality of perforations, the perforations are slot-shaped and the alignment posts are shaped to correspond to said slot-shaped perforations.

46. The method according to claim 41, wherein the at least one alignment post of the label applicator system is shaped to prevent rotation of the label about the at least one alignment post upon installation thereon.

47. The method according to claim 41, wherein the label sheet further comprises a pair of case spine labels made with a cut through the top layer of the label sheet.

48. The method according to claim 41, wherein the label sheet comprises a pair of disc-shaped labels for installation on discs.
